(19) United States
(12) Patent Application Publication
(10) Pub. No.: US 2017/0064321 A1
(43) Pub. Date: Mar. 2, 2017

(54) SYSTEM AND METHOD FOR DECODING A VIDEO DIGITAL DATA STREAM USING A TABLE OF RANGE VALUES AND PROBABLE SYMBOLS

(71) Applicant: STMICROELECTRONICS INTERNATIONAL N.V., AMSTERDAM (NL)

(72) Inventors: Vindhyeshwari Kumar KASHYAP, Greater Noida (IN); Ajit Singh MOTRA, Greater Noida (IN); Mahesh Narain SHUKLA, Noida (IN); Tarun SINGAL, Noida (IN)

(21) Appl. No.: 14/837,051

(22) Filed: Aug. 27, 2015

(51) Int. Cl. H04N 19/44; H04N 19/85; H04N 19/423; H04N 19/436

(52) U.S. Cl. CPC H04N 19/44; H04N 19/436; H04N 19/85; H04N 19/423

(57) ABSTRACT

A video decoder includes an input configured to receive a plurality of bins of a video digital data stream to be decoded. A processor and a memory associated therewith are configured to perform parallel decoding of multiple bins of the plurality of bins in a given processing cycle based upon a table containing delta range values and probable symbols.

### TECHNICAL FIELD

The present disclosure relates to decoding data, and more particularly, decoding multiple bins of a video digital data stream.

### BACKGROUND

The Audio and Video Coding Standard (AVS, also includes AVS+) specifies a new standard for audio and video coding and its transport protocols. AVS uses a block-based coding process where the image or frame is divided into blocks, usually a 4×4 or 8×8 block, and the blocks are transformed into coefficients, quantized, and entropy encoded. The entropy H(X) is the minimum rate by which a discrete source X with alphabet {x₁, x₂, . . . , x_{N}} can be losslessly encoded. Entropy defines a code C, which allows the encoding of the source alphabet by approximately the rate of entropy. This is possible using Variable Length Codes (VLC). A prerequisite is integer bit allocation, i.e., each symbol is coded with an integer number of bits. This constraint is overcome by arithmetic coding, which assigns a code to a whole message, rather than to source symbols. Each symbol of the message is encoded with a fractional number of bits, thus achieving a final rate which is closer to the entropy.

The transformed data is not actual pixel data, but the residual data following a prediction operation that is intra-frame, i.e., block-to-block within the frame or image. This is also termed motion prediction. In AVS, the coding of quantized transform coefficients takes advantage of the transform characteristics to improve the compression. These coefficients are coded using a sequence known as the Level, Run, Sign, and End-of-Block (EOB) flag. Level and Run correspond to the numeric value of video pixels. For example, the coding is in a reverse zig-zag direction and starts from the last non-zero coefficient in the zig-zag scan order for a transformed block. This requires the EOB flag. The Level-minus-one and Run data are binarized using unary binarization and the bins are coded using context-based entropy arithmetic coding for the transformed coefficient data.

The advanced entropy coding in AVS has three main processes: 1) binarization, 2) context modeling, and 3) binary arithmetic coding (BAC). The binary arithmetic coding is a mix of logarithmic domain and original domain. AVS uses domain arithmetic coding and has a high bin-to-bit ratio of about 10, unlike other standards such as H264/H265, which is about 3.5. This high ratio results from the unary binarization used for the transformed coefficients. Due to the high bin-to-bit ratio, one bin per cycle is not sufficient to achieve a specification demanding up to 2G bins per second.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A video decoder comprises an input configured to receive a plurality of bins of a video digital data stream to be decoded. A processor and a memory are associated therewith and configured to perform parallel decoding of multiple bins of the plurality of bins in a given processing cycle based upon a table containing delta range values and probable symbols.

Accordingly, it is possible to sustain a high bins-per-second requirement with a significantly lower clock and which also makes the hardware as part of the video entropy decoder more efficient in power consumption.

The probable symbols each may comprise a logarithmic probability of a symbol and a given processing cycle may comprise a single clock cycle. The processor may be configured to calculate the delta range value for each symbol and store it in the memory. The processor may also be configured to calculate the probable symbols and store the calculated probable symbols in the memory. The table may comprise columns or rows, each corresponding to a respective bin and holding a delta range value and probable symbol, wherein the processor is configured to iterate through each column or row and update a delta range value and probable symbol. The table may comprise a two-level table having a first coarse level containing multiples of delta range values and probable symbols, and a second fine level containing any remainder delta range values and probable symbols. The processor may be configured to perform inverse binarization after parallel decoding to form original symbols that had been encoded.

A method of decoding a video digital data stream comprises receiving within a decoder having a processor and a memory associated therewith a plurality of bins of a video digital data stream to be decoded. Multiple bins are processed in parallel in a given processing cycle for decoding the multiple bins based upon a table stored in the memory containing delta range values and probable symbols.

The probable symbols may each comprise a logarithmic probability of a symbol. The processing during a given processing cycle may comprise processing the multiple bins in a single clock cycle. The delta range value for each symbol is calculated and stored in the memory. The probable symbols are calculated and stored in the memory.

The table may comprise columns and rows each corresponding to a respective bin and holding a delta range value and probable symbol. The method further comprises iterating through each column or row and updating a delta range value and probable symbol. The table may comprise a two-level table with a first coarse level containing multiples of delta range values and probable symbols and a second fine level containing any remainder delta range values and probable symbols. The method may comprise performing inverse binarization after parallel decoding to form original symbols that had been encoded.

### BRIEF DESCRIPTION OF THE DRAWINGS

Other objects, features and advantages will become apparent from the detailed description of which follows, when considered in light of the accompanying drawings in which:

FIG. 1 is a flowchart depicting a process of decoding in accordance with a non-limiting example.

FIG. 2 is a high-level block diagram of basic components of the video decoder in accordance with a non-limiting example.

FIG. 3 is a high level block diagram of the video decoder operation in accordance with a non-limiting example.

FIG. 4 is a more detailed block diagram of the video decoder in accordance with a non-limiting example.

FIG. 5 is a logic diagram showing pseudocode for the decoder operation in accordance with a non-limiting example.

FIG. 6 is a high-level diagram of a cascaded multibin decoder in accordance with a non-limiting example.

FIGS. 7A and 7B are block diagrams showing greater details of the cascaded multibin decoder of FIG. 6 in accordance with a non-limiting example.

FIG. 8 is a table showing an example of unary binarization in accordance with a non-limiting example.

FIG. 9 is a high-level diagram of a table-based multibin decoder in accordance with a non-limiting example.

FIG. 10 is a high-level diagram of a two-level table used in the multibin decoder in accordance with a non-limiting example.

FIGS. 11A and 11B are block diagrams showing greater details of the table-based multibin decoder in accordance with a non-limiting example.

FIG. 12 is a graph showing results of multibin processing for the bin/cycle in accordance with a non-limiting example.

FIG. 13 is a graph showing results of multibin processing for bits/cycle in accordance with a non-limiting example.

### DETAILED DESCRIPTION

Different embodiments will now be described more fully hereinafter with reference to the accompanying drawings, in which preferred embodiments are shown. Many different forms can be set forth and described embodiments should not be construed as limited to the embodiments set forth herein. Rather, these embodiments are provided so that this disclosure will be thorough and complete, and will fully convey the scope to those skilled in the art.

In the following description, embodiments are described with reference to the AVS standard for video coding and the developing AVS2 standard and AVS+. However, the disclosure is not limited to AVS, AVS+ or AVS2, but applicable to other video encoding and decoding standards related to AVS, including possible future standards. Throughout the description, the term AVS will be used to correspond generally to those different versions of AVS.

In AVS, a frame may contain one or more slices and the encoding and decoding may occur on a frame-by-frame, a slice-by-slice, picture-by-picture, or tile-by-tile basis. It is possible a frame may be divided into one area for screen content and another area for natural video, sometimes referred to as a split screen. A multiview CODEC may be used.

A general description of AVS encoding and decoding now follows to gain a better understanding of the AVS multibin decoding in accordance with a non-limiting example.

An AVS encoder uses entropy encoding, which losslessly compresses symbols that include not only data that is a direct reflection of the transformed quantized coefficients, but also includes data related to the current block, such as the intra-prediction mode, and flags that allow zero-value data to be skipped. Quantized coefficients are “level-run” encoded due to the prevalence of zero-valued coefficients. This involves generating level-run ordered pairs with each pair having a magnitude of a non-zero coefficient followed by the number of consecutive zero-valued coefficients in a reverse scan ordering. The symbols representing both the transformed quantized coefficients and other data related to the current block are unary binarized and entropy encoded.

This level-run encoding involves scanning quantized transformed coefficients in a reverse zig-zag scanning order and generating pairs as the “level,” i.e., the magnitude of a non-zero coefficient and a “run” as the number of consecutive zero-valued coefficients following that non-zeroed coefficient in the reverse zig-zag order before the next non-zero coefficient. The level-run pairs are binarized in unary code and entropy encoded, typically by arithmetic entropy coding. In AVS, the decoder receives a compatible bit stream and produces the reconstructed video. The entropy decoder takes the entropy decoded block of quantized transformed coefficients and dequantizes them to reverse the quantization that was imparted at encoding.

The AEC (Advanced Entropy Coding) algorithm provides high coding efficiency. Encoding and decoding both take place at the bin level in AEC. Binarization changes the value of a numeral, e.g., “five” corresponding to a video pixel value, for example, to a binary form. That specific sequence of binary strings pointing to that value is called a binarization, i.e., a bin. Each bin is encoded to obtain a compressed output.

Unary binarization is used for encoding the coefficients in AVS. Specific contexts are selected before encoding each bin. After encoding each bin, the resultant contexts are saved to enable subsequent encoding. Along with contexts, the range (known as s1 and t1) is modified and in subsequent encoding this range is used. The reverse process is followed while decoding. To decode a bin, the range and related context are known. Since context selection and range is identified after decoding the bin, the subsequent decoding of a new bin must wait because of data dependency. In the more current AVS systems, it is possible to apply a look-ahead method to avoid subsequent bin decode as part of a one cycle per bin approach. Usually look-ahead methods form tree branches where possible combinations are precalculated. Based on results of the current calculated bin, subsequent precalculated bins are directly chosen. The tree branches depend on the depth (number of bins) which have been targeted. This results in greater hardware cost, which increases exponentially with each additional depth.

For a conventional AVS decoder, the results of sample streams corresponding to a one-bin-per-cycle approach are obtained (Table 1) when running a trial at 200 MHz:

TABLE 1
Stream profiling for bits per sec and bins per sec

| | M | M | |
|---|---|---|---|
| | Bins | Bits | MB |
| | per | per | per |
| Stream Name | sec | sec | sec |
| (SS1) 52_Tsinghua_HS_0_0_0x48.avs | 196 | 38 | 110086 |
| (SS2) CrowdRun_test_25_clipped-3-47.avsp | 182 | 134 | 615157 |
| (SS3) CrowdRun_test_39_clipped-23-44.avsp | 196 | 102 | 64639 |
| (SS4) FC1_32×32_IPB_QP4_FR8_test.avs | 198 | 34 | 9718 |
| (SS5) FC1_1920×1080_IPB_QP4_FR8_test. | 198 | 32 | 9802 |
| avs | | | |

With a conventional AVS decoder, this system can reach 275 MHz for one bin/cycle. To achieve the newer and more desirable AVS targets of about 200 Mbps, 2 Gbin/s 4K@60 fps, the clock requirement must be about 1,000 MHz to meet those stream requirements shown in Table 1. Using a higher clock is desirable to decode multiple bins per cycle and consume bits with a higher rate. It may be desirable, then, to improve the decoding time of coefficients and achieve those targets identified above.

A conventional AVS decoder receives an encoded bit stream as a sequence of frames, each corresponding to a different point in time. It processes one frame (or slice) at a time on a block-by-block basis. Temporal prediction is used in a feedback loop that includes a dequantizer and inverse spectral transformer. Residual data is input to the spectral transformer in a spatial domain and the data corresponds to pixels arranged in geometric rows and columns. The output data contains frequency information about the pixels from which the pixels can be reconstructed. AVS uses transform coding and operates on a block, for example, a 16×16 macro block containing four 8×8 transform blocks.

The transformed coefficients indicate there are three advantages in the AVS processing, which can be used to achieve the following targets: (1) coefficients are unary coded and syntax elements are terminated when the decoded value of a bin is equal to one; (2) renormalization takes place when there is a LPS (Least Probable Symbol); and (3) the Cwr (fast adaptive factor) has three values. After initial decoding, this value attains a fixed value, and thus, it helps in reducing the possible tree-branches. Any multibin decode processing, however, does not occur until the fixed value is obtained because it may limit performance. The first two algorithm advantages identified above allow the system to remove the tree-branches and realize a single pipe of hardware to calculate the multiple bins at once.

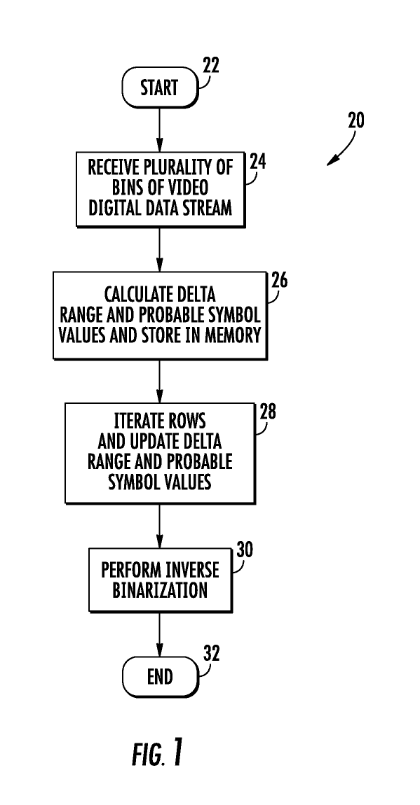

Referring now to FIG. 1, a high-level flow diagram of the process for decoding a video digital data stream, in accordance with a non-limiting example, is illustrated at 20. The process starts (Block 22) and the process receives a plurality of bins of video digital data stream to be decoded (Block 24). The delta range values and probable symbols corresponding, in one example, to a logarithmic probability of the most probable symbol are calculated and stored in memory (Block 26). The method iterates through each row of a table and updates a range value and probable symbol (Block 28). The method continues with inverse binarization after parallel decoding to form original symbols that have been encoded (Block 30) and then ends (Block 32).

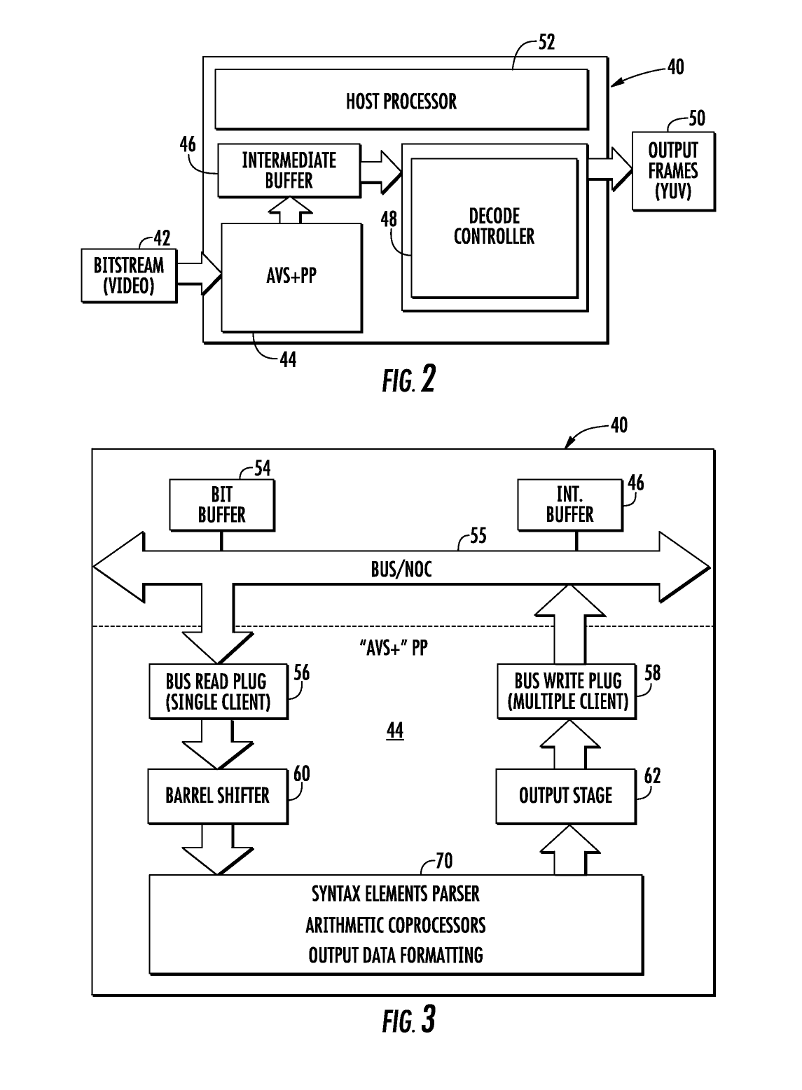

Referring now to FIG. 2, the data flow through the AVS decoder 40, in accordance with a non-limiting example, is illustrated and shows a video bit stream 42 that enters an AVS pre-processor 44 followed by intermediate buffering in a buffer 46 and further processing in a decode controller 48. Frames are output 50. The decoder 40 will also use parsing, entropy decoding, and inverse transformation. A host processor 52 programs and controls the frame level. The decoder controller 48 controls decoding below the frame level. In the intermediate buffer 46, data is provided to the decoder controller 48 to complete the decoding. The intermediate buffer 46 may include data that is entropy decoded.

The video digital data stream is a sequence of bits that form the representation of coded pictures forming one or more coded video sequences. A start code is a unique code word of 32 bits embedded in the bit stream. Emulation prevention, sometimes referred to as anti-emulation, allows bytes forming the video digital data stream to have the two lower significant bits of a target byte dropped. AVS uses a lossless data compression such as Golomb coding and context-based adaptive binary arithmetic coding (CBAC). A slice is an integer number of macro blocks ordered consecutively in the raster scan. The macro block is a 16×16 block of luma samples and two corresponding blocks of chroma samples. The processor includes start code detection (SCD) and emulation prevention code removal or an anti-emulation code removal (ECR also known as AECR). The system includes an interconnect for a system-on-chip (SOC) application as part of the BUS/NOC.

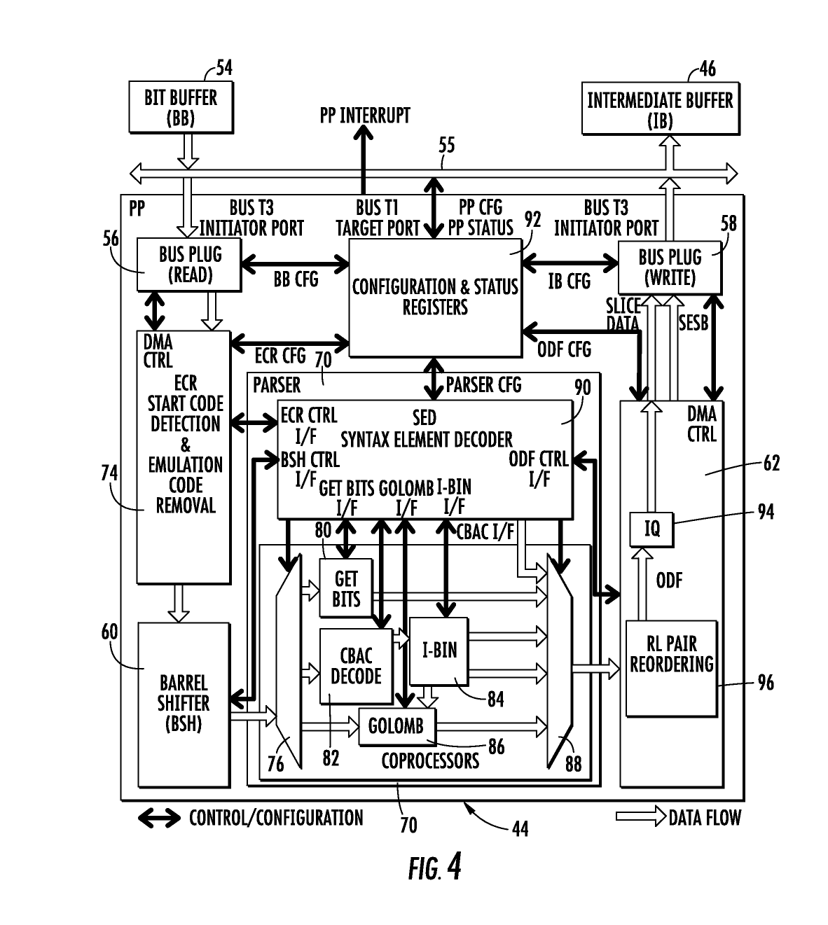

Referring now to FIG. 3, a high-level block diagram of the pre-processor 44 of FIG. 2 is shown, in accordance with a non-limiting example. In the AVS decoder 40, the pre-processor 44 is located between a bit buffer 54 that holds the encoded bit stream and the intermediate buffer 46 that inputs data to the decode controller 48 via the bus 55. The pre-processor includes a bus read plug 56 and bus write plug 58 that interoperate respectively with a barrel shifter 60 and output stage 62. A parser 70 operates for syntax element parsing, arithmetic coprocessing, and output data formatting. The pre-processor 44 provides the hardware capability to decode advanced entropy coded (AEC) symbols that are a form of context adaptive entropy coding. The pre-processor 44 receives data from the input bit buffer 54 where the bit stream is stored together with those parameters that are required to parse a header in the bit stream. The output is stored in the intermediate buffer 46. The pre-processor pre-processes data for the decode controller 48 at a frame level.

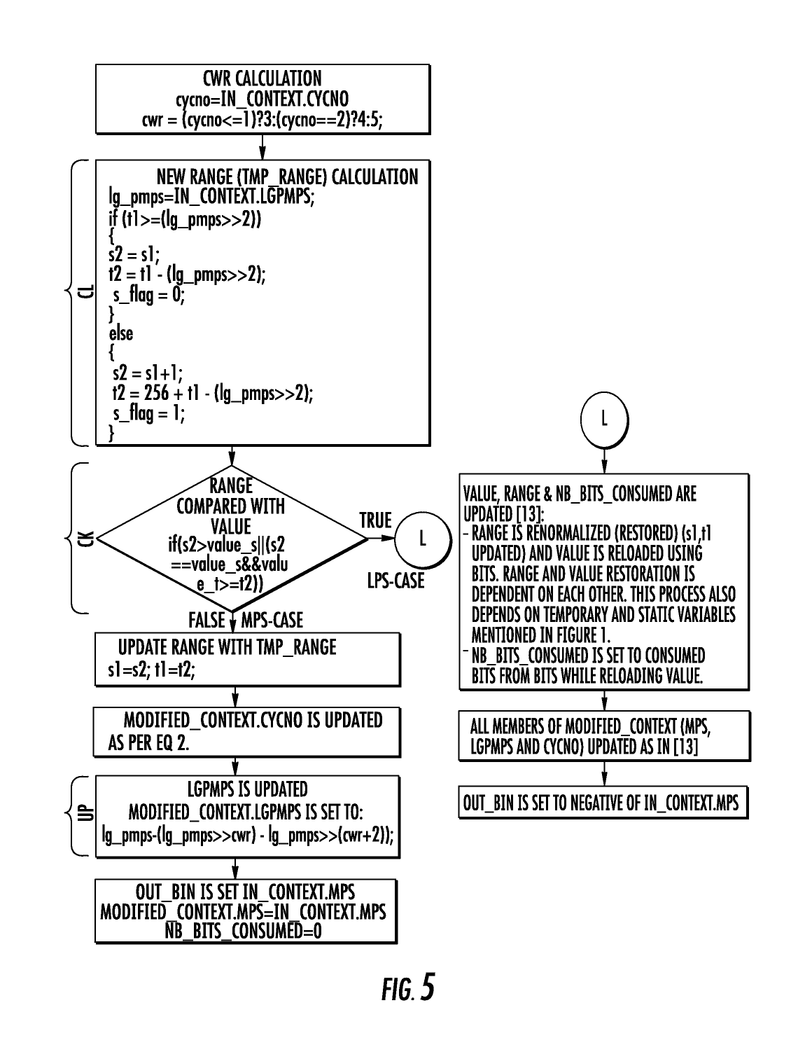

Referring now to FIG. 4, there is shown a more detailed block diagram of the pre-processor 44 used in the decoder 40 in accordance with a non-limiting example. The bit buffer 54 and intermediate buffer 46 connect to the respective read and write bus plugs 56, 58. Data flows from the read bus plug 56 through a start code detection and emulation code removal (ECR) circuit 74 to the barrel shifter (BSH) 60 into a parser 70 having various coprocessors via a demultiplexer 76. The various coprocessors include a Get Bits 80, CBAC decoder 82, I-bin 84 (inverse binarization), and Golomb 86 coprocessors. Each coprocessor interoperates with a Syntax Element Decoder (SED) 90, which in turn, interoperates with Configuration and Status Registers 92. Data from the Syntax Element Decoder 90, Get Bits coprocessor 80, I-bin coprocessor 84 and Golomb coprocessor 86 are multiplexed 88 into the output stage 62 shown as an output data flow (ODF) module, which includes an inverse quantization module 94 and the run/level (RL) pair reordering 96. The output stage 62 may be formed as a direct memory access (DMA) unit. In this decoder 40, the multibin table processing as described in greater detail below occurs in the CBAC decoder coprocessor 82.

The Bit Buffer 54 is a circular buffer holding compressed elementary stream (ES) data. The pre-processor 44 uses bit stream handling to read the bit buffer, detect a start code, remove emulation prevention code in the ECR 74, and perform bit-aligned operations using the barrel shifter 60. The parser 70 reads and analyzes the AVS syntax and decodes the CBAC syntax with the various coprocessors. The bit buffer 54 also contains the sequence of bits that form the representation of coded pictures and associated data forming one or more coded video sequences separated by a start code, which are byte aligned in the bit buffer. Each start code includes a start code prefix followed by a start code value. The start code prefix is a string of 23 bits with a value of 0 followed by a single bit with the value 1. All start codes are byte aligned.

Certain “syntax elements,” i.e., symbols may contain the same bit stream structure as in a start code prefix and are called start code emulation. This bit stream structure includes a video stream, with “N” sequences and each sequence including different frames up to “N” frames, and each frame including a header and “N” slices. The sequence includes a sequence header that includes information regarding the profile, level, resolution, format, frame rate, and bit rate and other details.

The video frame also includes an I or PB header with the I header including information regarding the G-picture, picture structure, and field information. The PB header includes information regarding the S-picture, picture coding type, picture structure and field information. The pre-processor 44 will parse and pre-process data. Most other start codes are ignored by the pre-processor 44.

During decoding, a target byte is read and the pre-processor 44 checks two bytes before the target byte. If three bytes form a bit stream “0000 0000 0000 0000 0000 0010,” the two least significant bits (LSBs) of the target byte are dropped. Any user data and extension data do not form a string of more than 21 consecutive “0's.”

The pre-processor 44 parses the data and bypasses other segments of syntax elements using the configuration registers 92. Basic syntax elements as symbols are found in the AVS specification. In AVS, the RS1 is a one 8-bit variable defined for the advanced entropy coding. As to the RS1, the AVS work group will add a limitation in the encoder to avoid the output for continuous 0>255 and change the RS1 to a 16-bit in the decoder and ensure there is no decoding abnormality. The read and write bus plugs 56, 58 shown in FIG. 4 read the bit stream and write to the separate buffers 54, 46. The write bus plug 58 interleaves data for multiple direct memory access circuits (DMAs) such as for the ODF 62 into a single bus interface. Programming of the plugs 56, 58 are accomplished using a configuration phase done before an actual decoding start command is launched. The configuration and status registers 92 are programmed through a port. The barrel shifter 60 manipulates bit aligned data and includes sub-functions of start code detection and marking (SCD) that detects and marks start codes used by the Syntax Element Decoder 90 in the parser 70 to begin operations depending on the start code and the anti-emulation code that removes the anti-emulation code from the bit stream.

The barrel shifter 60 is controlled by the parser 70 and includes the Syntax Element Decoder 90 where the bit stream syntax elements are parsed. This function occurs when the start code is detected and the parser 70 checks the type of start code. If the start code is a slice start code, it begins parsing and controls the coprocessors 80, 82, 84, 86 based on the type of encoding.

The decoder 40 uses the context-based binary arithmetic coding (CBAC) decoder 82 and the bins are decoded to make a bin string. If the bin string is found to be valid by binarization matching, the decoding of the current syntax element is finished and the syntax element value is produced by de-binarization. Decoded symbols as syntax elements are input to the ODF 62, which includes the inverse quantization (IQ) 94 and the RL pair reordering 96. The ODF 62 formats and operates as a buffer. The intermediate buffer (IB) 46 contains the entropy decoded data that is required by a pixel decode pipeline to decode the stream and defines a data format that is used by other circuit blocks to extract required data. This intermediate buffer 46 is optimized for memory usage. After entropy decoding, any slice status and error information for each slice is stored at the beginning of the intermediate buffer and the amount of storage for each status and error information word is the same for each slice and the area is arranged in the same order as slices.

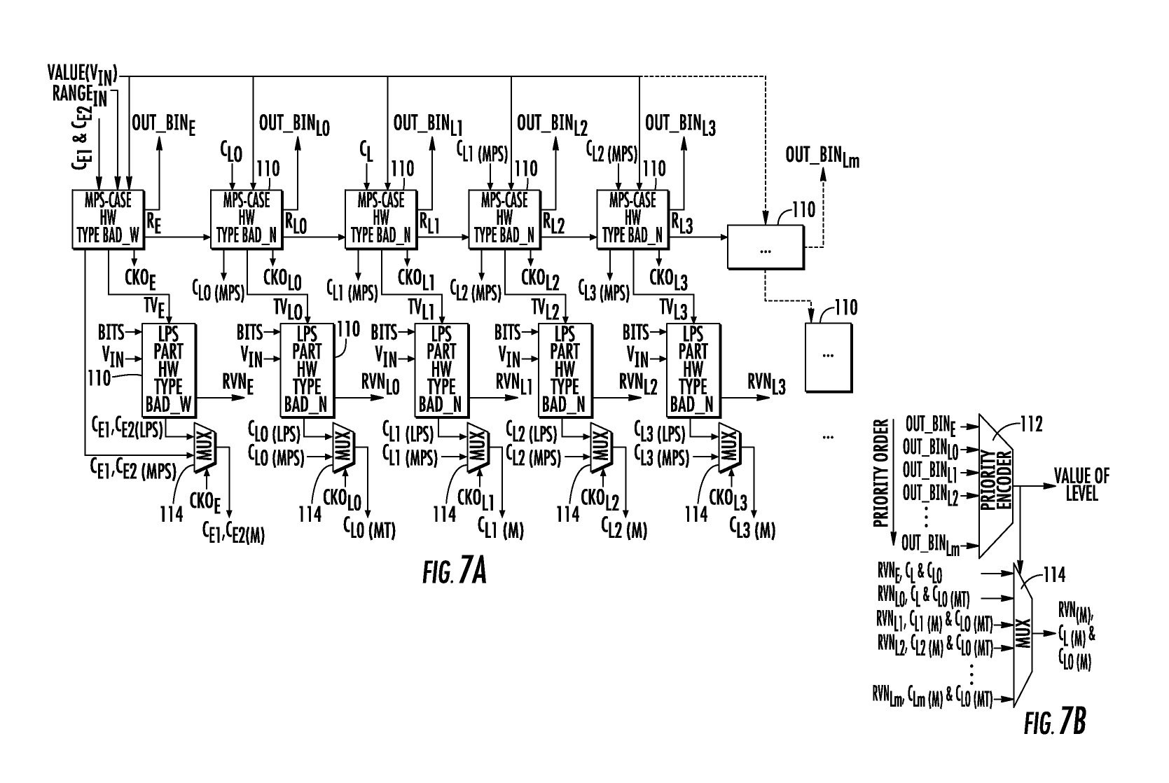

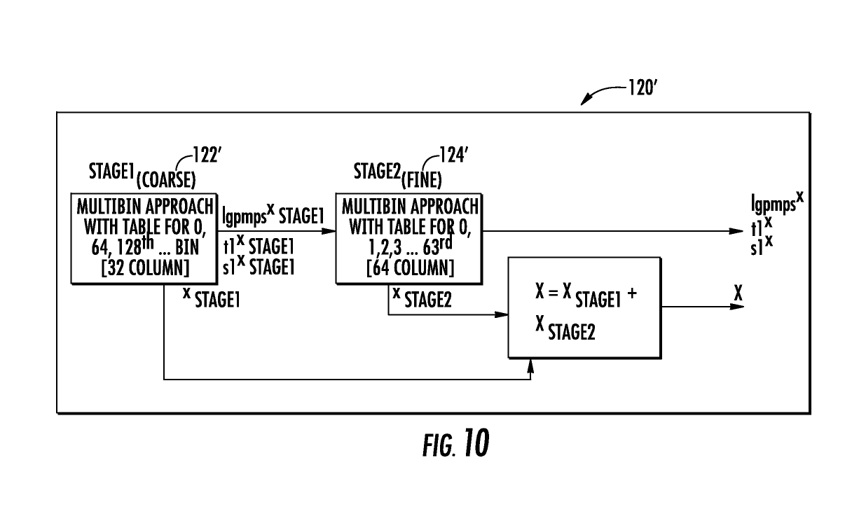

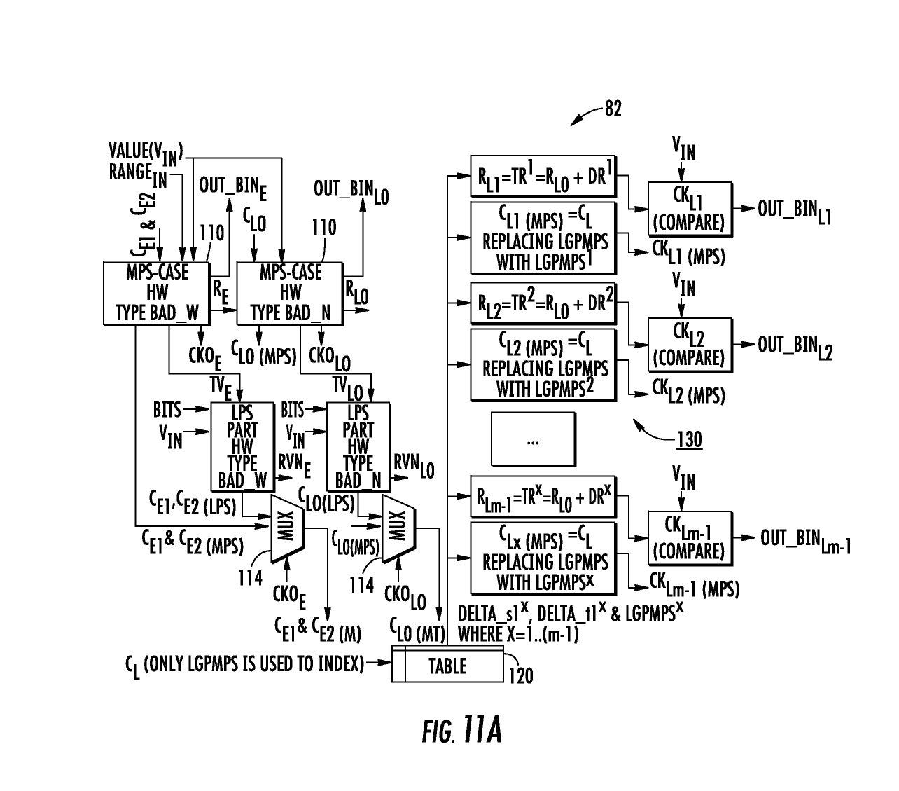

The CBAC decode coprocessor 82 shown in FIG. 4 may include a cascaded architecture for the multibin decoder processing as shown in the example of FIG. 6 or the preferred table-based approach as shown in FIGS. 9 and 10. The decode algorithm, in accordance with a non-limiting example, includes context selection, bin decode and context update. When maintaining the context memory as a register in hardware, the processing steps can be accomplished in a single cycle for each bin. Computation steps are attempted in a fraction of a cycle and use hardware replication to cascade and feed the output of one to the input of another.

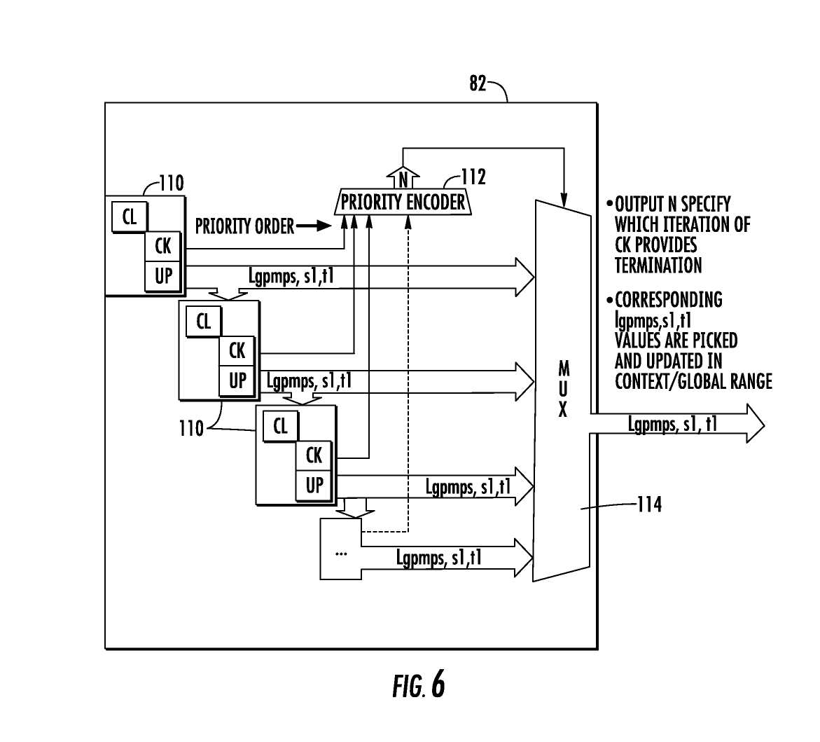

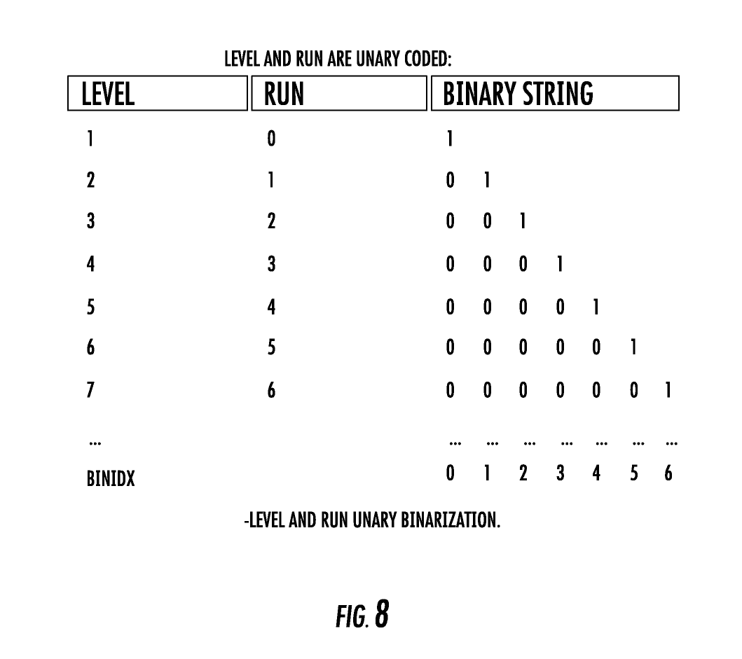

The bin decoding algorithm for a decode element is split in three parts to perform independent calculations in parallel as much as possible. The bin decoding includes the following sub-parts: Calculate [CL], Check [CK] and update [UP], which are shown in the example source code of FIG. 5 and used in the cascaded architecture shown in FIG. 6 for each cascade decode element as explained below. The example source code shown in FIG. 5 corresponds to the decode function in a decode element 110 for a bin as shown in FIG. 6, showing the CBAC decode coprocessor 82. The cascaded decode elements 110 in FIG. 6 each operate with a range as S1 and T1 and a probable symbol, which in this example is a logarithmic probability of the most probable symbol (LGPMPS). Each decode element 110 forms the calculation, check, and update for the most probable symbol as shown in the pseudocode of FIG. 5. Outcomes from each decode element 110 are passed into a priority encoder 112 from the check sequence. Output is multiplexed in multiplexer circuit 114. Update occurs for the probable symbol and the range as indicated in the arrow from the update portion of each decode element 110 to the multiplexer 114. The output N specifies which iteration of the check (CK) provides a termination, while the corresponding probable symbol as the logarithmic probability of the most probable symbol and the range as S1 and T1 values are picked and updated in the context/global range. Each cascaded decode element 110 corresponds to a binary arithmetic decoder (BAD) element as shown in FIGS. 7A and 7B. In those figures, the normal binary arithmetic decoder element has acronym BAD. The most probable symbol is referred to with the acronym MPS and the least probable symbol as LPS.

As s1 & t1 pertaining to the range remain constant, there is no need for tree-branch like hardware. Since termination of the syntax element or symbol is based on a bin value equal to 1, as soon as the Check (CK) detects bin value 1, the system terminates decoding. The outcomes are fed to the priority encoder 112 as shown in FIG. 6 where the priority order is from left to right. The foremost block which signals Bin value 1 is chosen and the output is selected. All the calculations of subsequent blocks are discarded. As a consequence, at the end of the logic sequence, the system jumps over multiple bins and the output N indicates the number of bins and also outputs the final bin, which is necessary when the number of bins in the syntax element exceeds the number of stages. The system continues decoding the same element in the next cycle.

This cascaded circuit shown in FIG. 6, however, is not easily scalable. For each stage of the decoder element 110, there is an additional fraction of a clock cycle consumed, resulting in a higher time period as the Multibin capability is increased. A minimum frequency to meet bit-rate is also a constraint. Increasing the stages will impact the maximum achievable bit-rate.

A more detailed chain of cascaded decode elements 110 is shown in FIGS. 7A and 7B, illustrating the cascaded decode elements 110, each formed as a normal binary arithmetic decoder (BAD) element for a single clock cycle, but cascaded together, and showing the priority encoder 112 and multiplexer 114. The following legends help to understand the flow:
RVN_{X} compositely represents RANGE, VALUE & NB_BITS_CONSUMED from LPS-PART hardware (the decode element for least probable symbol).
Subscript VARIABLES(X) signals the modified value VARIABLES after being processed by the cascaded hardware block.
R_{X} represents RANGE from the MPS (Most Probable Symbol)-CASE hardware for a decode element 110.
TVX represents TMP_RANGE and other temporary variables from MPS-APPLICATION hardware decode elements 110.
CKO_{X} represents bin decision output (from a CK sub-split) from MPS-CASE hardware decode elements 110.
   X is a Bin from set [E, L0, L1, L2 . . . Lm].

Each transform coefficient (ELSR) is part of the following four values (in sequence):
optional end of block (EOB)
value of level (LEVEL)
sign of level (SIGN)
value of run (RUN)

The cascaded hardware of decode elements 110 illustrated in FIGS. 7A and 7B is capable of decoding all Bins from the EL bin-string (value of LEVEL) in a single cycle. The priority encoder 112 output (LEVEL) is also used to select the correct output of RVN and Contexts to be used for subsequent bin decoding.

The cascaded approach shown in FIGS. 6, 7A and 7B is not forming a tree-like structure as accomplished in one bin/one cycle look-ahead methods. It is a single chain (without tree-branches) of cascades and hardware blocks which saves hardware costs. To decode EL (from ELSR) completely in a single cycle, it is necessary to have 2048 stages of deep cascaded hardware decode elements 110. Any achievable frequency in that design will be low. For the requirements as described before, it is around 0.8 MHz [1/(2047*0.6 ns+1.1 ns)], where 0.6 ns is assumed for the time needed for one stage and 1.1 ns is the fixed overhead, and there is no trade-off point to achieve a target, and hence, the invention proposes a novel table-based multibin decoder in hardware to eliminate these stages. This is referred to as the table-based multibin arithmetic decoding.

To make this cascaded approach scalable, it is possible to exploit another algorithmic variable as the lgpmps (logarithmic probability of the most probable symbol), which can have value from 0 to 1023. Because there is a fixed calculation in each decoder element stage which is fed to the next, it can be precalculated and kept in a ROM table or managed with a multiplexer with wires. The cascaded serial data can be broken with the help of a table. Based on the lgpmps, if an N-stage multibin process is to be used, it is possible to create a table with N columns (or rows) having a value for the intermediate variables (lgpmps, t1 & s1). One row (or column) is accessed at once. Each includes precalculated values corresponding to 1, 2, . . . N Bins. Each value is precalculated assuming the CK (check) results in a FALSE. Effective values are calculated pursuant to the pseudocode steps in FIG. 5 with Calculate (CL), Check (CK), and Update (UP) sequence of steps:

{CL,CK=FALSE,UP}xN

A parallel CK step hardware is in place for each N Bins. The output from each CK step will arrive at once. It breaks cascading and allows to scale with multibin calculations without decreasing frequency. The output of the parallel CK Step is fed to the priority encoder 112 as explained in the staging or cascaded multibin processing above. The rest of the process is the same. The multibin processing can be made scalable with a table approach.

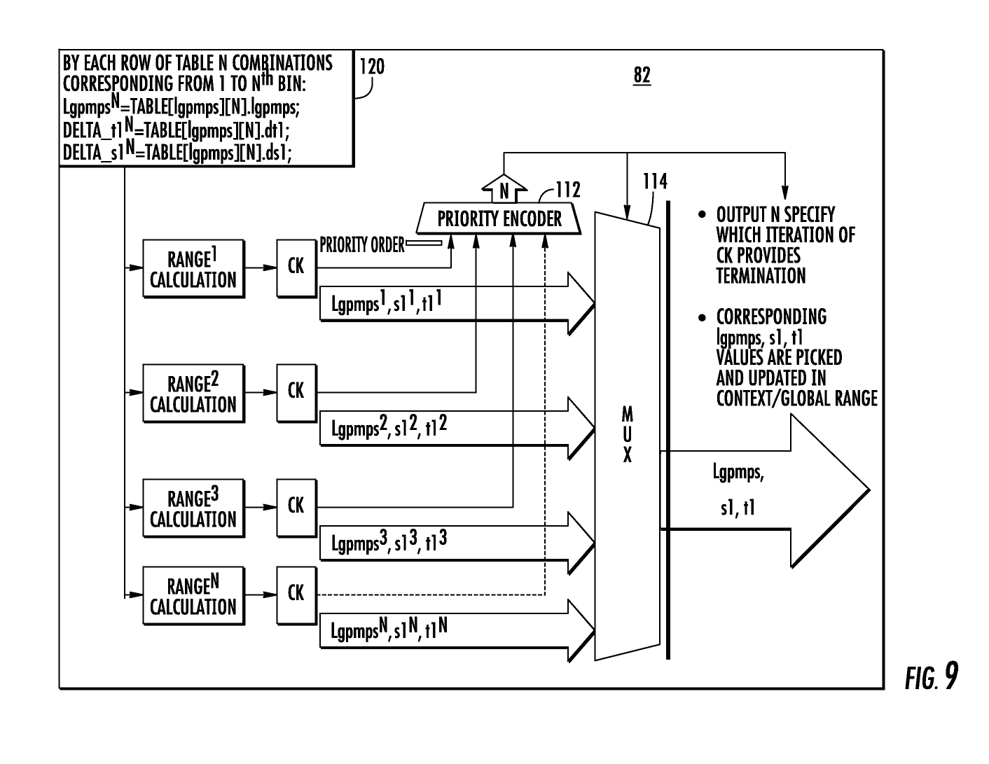

The SIGN & EOB are single Bins whereas the RUN and LEVEL can be encoded in multiple Bins based on their values. To decode the EOB Bin, two contexts are required. To decode SIGN, there is no context requirement. To decode Bins of RUN or LEVEL, the table-based system requires a maximum of two contexts depending on the Bin. Except for first Bin of RUN or LEVEL, the context for subsequent Bins remains the same. The LEVEL and RUN are unary coded as shown in the example of FIG. 8.

It is possible to use a hybrid approach which involves the multibin processing and staging with a limited look-ahead tree-branch based approach in combination with the multibin processing and table approach. Basic components of the Bins, Sign and EOB are illustrated with the table look up and Bin Termination (BIN-TERM). Instead of decoding SIGN & EOB separately, both the Bins can be grouped as follows:
[EOB, LEVEL]=>EL
[SIGN, RUN]=>SR

This grouping of EL and SR allows the combined decoding of EOB+LEVEL in a single cycle and combined decoding of SIGN+RUN in single cycle. EOB+L0 is approximately the same time duration as L(1 . . . N−1)+LN. Also SIGN+R0 is approximately the same time duration as R(1 . . . N−1)+RN. EOB+L0 or SIGN+R0 may be referred to as ELSR-TOP and L(1 . . . N−1)+LN or R(1 . . . N−1)+RN as ELSR-BOTTOM. To increase the frequency (to meet bitrate), it is possible to decode ELSR-TOP in one cycle and ELSR-BOTTOM in another cycle.

Stages other than E and L0 in FIG. 7A are cascaded from one MPS-CASE HW stage 110 to another. RANGE (R_{X}) is also cascaded in same way. A table in the multibin table based approach is built to jump over those multiple stages and eliminate hardware operators. To keep the table size as low as possible, the system eliminates variable participation as much as possible without having significant impact on achievable performance. The majority of variables are eliminated if the table is built on the basis that the outcome of the CK (CKO_{X}) is always false. The variables which go out of participation are BITS, VALUE (V_{IN}), TV_{E}, C_{X(LPS)}, RVN_{X}. Assuming CWR=5, the lgpmps calculation is reduced. Effectively, the system eliminates the variable participation of the CYCNO (cycle number). The MPS (from CONTEXT) can also be eliminated. The table is built assuming MPS is 0. The system exploits the use of unary binarization. If MPS=1 and CKO_{X} is 0, the decoding is terminated.

The following three variables are left for the table: RANGE which is actually 1) s1 (16-bit) and 2) t1 (8-bit), and 3) the probability of a symbol, corresponding in this example, to the logarithmic probability of the most probable symbol, LGPMPS (10-bit). Given the current value of LGPMPS, after jumping over N-stages of MPS-CASE, RANGEN (s1^{N}, t1^{N}) can be calculated as:

RANGE^{N}=RANGE+DELTA_RANGE^{N}

This equation can be split in terms of s1 and t1:

t1^{N}=t1+DETLA_t1^{N}

s1^{N}=s1+DELTA_s1^{N}
and if t1^{N} overflows (>=256):

t1^{N}=t1^{N}−256

s1^{N}=s1^{N}−1

Similarly LGPMPS^{N} can be calculated iteratively:

LGPMPS^{N}=N-th iteration of UP sub-split.

Using iterative CK and UP calculation, a table can be formed for the Nth iteration on the basis of LGPMPS (31-1023). LGPMPS cannot go below 31. An example table format is illustrated:

TABLE 2
Multibin Table with LGPMPS as Index

| | DELTA_s1¹, | DELTA_s1², | | DELTA_s1^{N}, |
|---|---|---|---|---|
| LGPMPS | DELTA_t1¹, | DELTA_t1², | | DELTA_t1^{N}, |
| (index) | lgpmps¹ | lgpmps² | . . . | lgpmps^{N} |
| 31 | 1, 249, 31 | 1, 242, 31 | . . . | . . . |
| 32 | 1, 248, 31 | 1, 241, 31 | . . . | . . . |
| . . . | . . . | . . . | . . . | . . . |
| 1023 | 1, 1, 985 | 2, 11, 948 | . . . | . . . |

FIG. 9 shows a high-level diagram of the CBAC decoder coprocessor 82 and its table 120 where each row of the table contains N combinations corresponding from 1 to the N^{th} bin. The decoding occurs in parallel for each bin for multibin processing with a range calculation followed by the checking (CK) function and the priority encoding in priority encoder 112. The processor uses the data values of the logarithmic probability of the most probable symbol (LGPMPS) and the data values S1 and T1. The output N specifies which iteration of the check CK function provides a termination. The corresponding LGPMPS, S1 and T1 values are picked and updated in the context/global range. The processing occurs in a single clock period. To maintain the table size to a minimum, it is possible to eliminate variables if the table is built on the basis where the outcome of CK is false. For example, assuming that the CWR=5, the LGPMPS calculation from the UP has a sub-split of the MPS-case hardware and is reduced. The symbol terminates with bin 1 and the table is designed for the assumption that the MPS is about equal to 0. The MPS is equal to about 1 with the assumption 1 will always be the last bin. The only variables left are the range as S1 and T1 and the LGPMPS.

There is an additive property with the level of domains and it is not possible to add two variables if one is a logarithmic domain and one is the normal domain. The additive property is determined and the table is formed with static values as the range. Depending on the current context of the probability, it is possible to directly jump to the next bin and update “N” bins. One row at a time is accessed. Because the current value of probability as the LGPMPS is known, the rows are accessed and the data for T1 and data for S1 for the bins are calculated. The range of the decoding is calculated for one bin, two bins and three bins and all sequential bins, and all data values are accessed. Summation for all the bins is accomplished and cascading is removed.

A two-level table 120′ for the multibin processing is shown in FIG. 10. There will be some frequency decrease and it will increase the clock period as comparable to a cascaded hardware approach. Coarse and fine stages 122′, 124′ are shown. The coarse stage table 124′ is set to 0, 64, and 128 bins and so on, and in the stage 2 table 124′, the remaining bins are determined. The clock period is slightly higher using the two-stage approach.

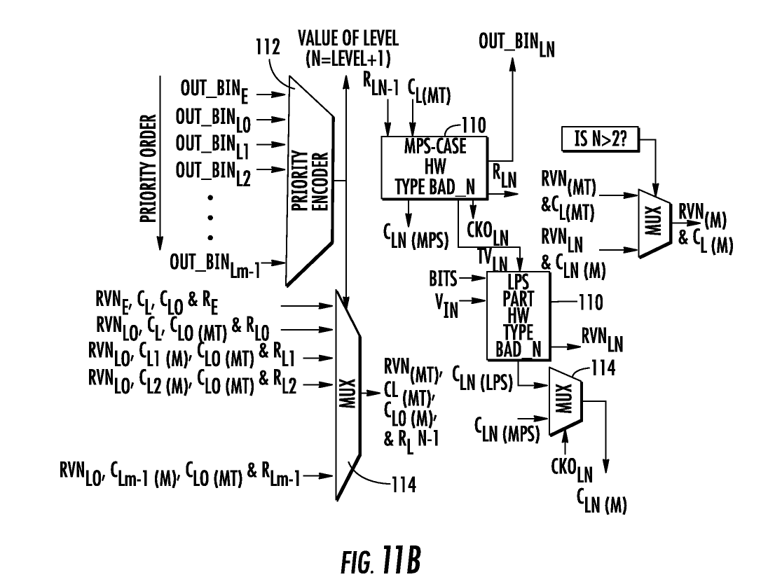

In the hardware, the table 120 is maintained in ROM or as a “Wire+Multiplexer” system. One row is accessed by using a value of the probability for a symbol LGPMPS as an index. The system obtains N entries of DELTA_s1/t1 and LGPMPS. The system calculates {s1¹, t1¹, LGPMPS¹}, {s1², t1², LGPMPS²}, . . . {s1^{N}, t1^{N}, LGPMPS^{N}}. s1/t1^{X}, TMP_RANGE^{X}, which is compared with the VALUE as per CK sub-split. In FIG. 11A, the staging requirement is removed from L1 Bin and onwards.

In FIGS. 11A and 11B, DR^{X} is DELTA_RANGE (s1, t1) and is read from the table 120 for Xth iterations and TR^{X} is TMP_RANGE. FIGS. 11A and 11B show the table-based approach with the logic decode elements 110 and multiplexer 114, but also operable with a comparison circuit 130 and table 120. Priority decoder 112, multiplexer 114, and other components as shown in FIG. 11B are similar to those of FIGS. 7A and 7B, but operate with the table 120.

After the E & L0 stage, other Bins starting from L1 onwards are decoded by table access. The calculations involved in TR^{X} & CK_{LX} are computed in parallel. With the table approach, the system directly jumps to a second to last Bin of the LEVEL. Finally, the last stage LN performs the termination and finishes cleanups of other variables. The benefit of the table approach gets active when the number of Bins in the SE is more than 4. The table access (multiplexer & wire form) along with calculations until the start of the LN stage takes around 0.8 ns (on 28 nm BULK) for a MultiBin table having 8-columns. The system achieves almost similar functionality as in cascaded hardware. The table based hardware output is equivalent to Cascaded hardware as in FIGS. 6, 7A and 7B except:

a) Limitation on CYCNO (cycle number). The table based Multibin decoding can only be done when CL is having CYCNO such that CWR is 5.

b) Limitation on MPS. The table based Multibin decoding is done when CL is having MPS equal to 0. As CL is known, the system switches to a fallback path of 3-stage cascaded hardware. If CKO is false, decoding is terminated unless the remaining Bins are decoded in other cycle(s). The loss in performance is limited by the definition of MPS (most probable symbol).

If an attempt is made to use a full table to jump all 2048 possible Bins, the level, table size, priority encoder 112 (leading one finder), and number of multiplexer 114 inputs increases. To optimize hardware further, the logic between the L0 stage and LN stage can be broken in two parts using the two-stage table 120. In the first stage 122′, a course jump is performed in steps of, for example, 64 bins. In a second stage 124′, the system performs fine jumps. The course table (C-Table) 122′ needs 32 columns and a fine table (F-Table) 124′ needs 64 columns to handle the possible Bins of LEVEL. The first column in the C-Table 122′ holds pre-calculated values of DELTA_s1, DELTA_t1 and LGPMPS with a 64 Bin depth. Similarly, the second column holds 128 bin depth and so on. The F-Table 124′ instead holds these parameters at single Bin depth (i.e., 1, 2, 3, etc.). To jump N Bins (LEVEL+1), where N=64*N_{CT}+N_{FT}, as first part, N_{CT} is done using the C-Table 122′. The system performs OUT_BINL:N_{CT} calculations for X=N_{CT}*64 where N_{CT} is 1, 2, 3, 4 . . . 32. The priority encoder 112 looks for OUT_BIN_{L}:N_{CT} having value 1 in order.

C_{L}:N_{CT}−1 is chosen along with R_{L}:N_{CT}−1. At this point, the system has decoded (NCT−1)*64 bins and updated Range and Context. To find the exact number of Bins which is between (N_{CT}−1)*64 and N_{CT}*64, variables R_{L}:N_{CT}−1 & C_{L}:N_{CT}−1 are cascaded to the 2nd level of Multibin table (F-Table) 124′. With CL:N_{CT}−1's LGPMPS and F-Table is accessed. To find N_{FT}, rest of the procedure remains similar to single level Table based Multibin approach explained before.

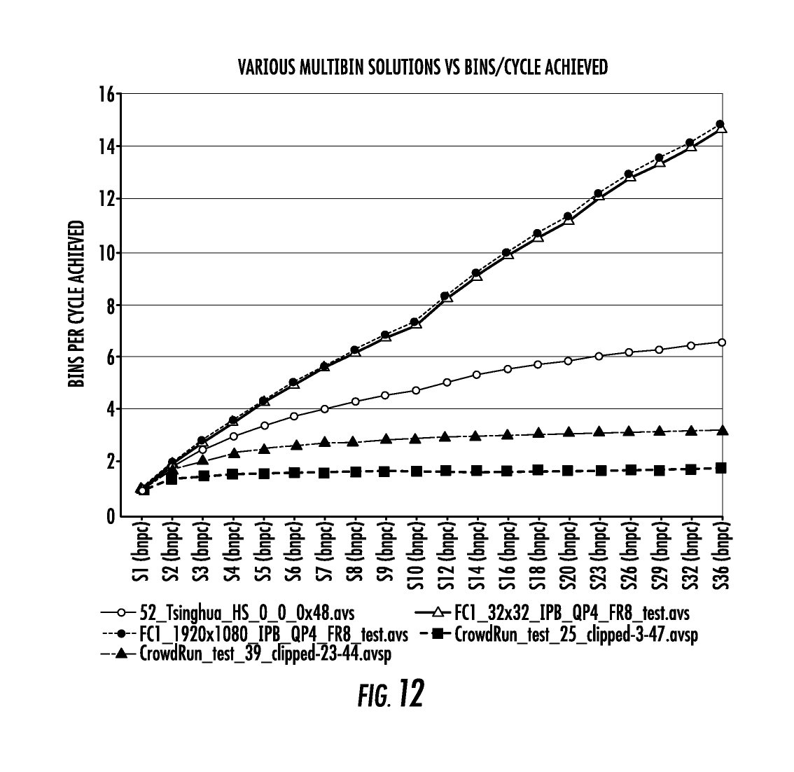

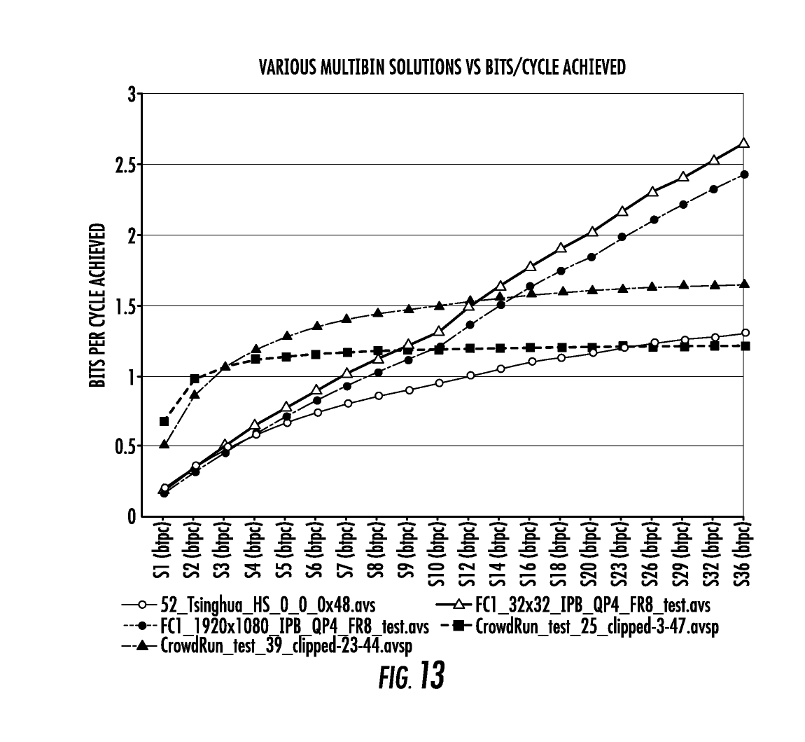

FIG. 12 is a graph showing the various multibin solutions where the bins/cycle and results achieved with the bins per cycle on the vertical scale and the column length on the horizontal scale. FIG. 13 is a graph showing the various multibin solutions vs. the bit/cycle results that are achieved with the bits per cycle achieved on the vertical axis.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A video decoder comprising:
an input configured to receive a plurality of bins of a video digital data stream to be decoded; and
a processor and a memory associated therewith and configured to perform parallel decoding of multiple bins of the plurality of bins in a given processing cycle based upon a table containing delta range values and probable symbols.

2. The video decoder according to claim 1, wherein said probable symbols each comprises a logarithmic probability of a symbol.

3. The video decoder according to claim 1, wherein said given processing cycle comprises a single clock cycle.

4. The video decoder according to claim 1, wherein said processor is configured to calculate the delta range value for each symbol and store it in the memory.

5. The video decoder according to claim 1, wherein said processor is configured to calculate the probable symbols and store the calculated probable symbols in the memory.

6. The video decoder according to claim 1, wherein said table comprises columns or rows, each column or row corresponding to a respective bin and holding a delta range value and probable symbol; wherein said processor is configured to iterate through each column or row and update the delta range value and probable symbol.

7. The video decoder according to claim 1, wherein said table comprises a two-level table having a first, coarse level containing multiples of delta range values and probable symbols; and a second, fine level containing remainder delta range values and probable symbols.

8. The video decoder according to claim 1, wherein said processor is configured to perform inverse binarization after parallel decoding to form original symbols that had been encoded.

9. A video decoder comprising:
an input configured to receive a plurality of bins of a video digital data stream to be decoded; and
a processor and a memory associated therewith and configured to:
perform parallel decoding of multiple bins of the plurality of bins in a given processing cycle based upon a table containing delta range values and probable symbols,
update delta range values and probable symbols contained in the table, and
perform inverse binarization after parallel decoding to form original symbols that had been encoded.

10. The video decoder according to claim 9, wherein said probable symbols each comprises a logarithmic probability of a symbol.

11. The video decoder according to claim 9, wherein said given processing cycle comprises a single clock cycle.

12. The video decoder according to claim 9, wherein said processor is configured to calculate the delta range value for each symbol and store it in the memory.

13. The video decoder according to claim 9, wherein said processor is configured to calculate the probable symbols and store the calculated probable symbols in the memory.

14. The video decoder according to claim 9, wherein said table comprises columns or rows, each column or row corresponding to a respective bin and holding a delta range value and probable symbol; wherein said processor is configured to iterate through each column or row and update a delta range value and probable symbol.

15. The video decoder according to claim 9, wherein said table comprises a two-level table having a first, coarse level containing multiples of delta range values and probable symbols; and a second, fine level containing any remainder delta range values and probable symbols.

16. A method of decoding a video digital data stream, comprising:
receiving within a decoder having a processor and a memory associated therewith a plurality of bins of a video digital data stream to be decoded; and
processing multiple bins of the plurality of bins in parallel in a given processing cycle for decoding the multiple bins based upon a table stored in the memory containing delta range values and probable symbols.

17. The method according to claim 16, wherein the probable symbols each comprises a logarithmic probability of a symbol.

18. The method according to claim 16, wherein the processing during the given processing cycle comprises processing the multiple bins in a single clock cycle.

19. The method according to claim 16, further comprising calculating the delta range value for each symbol and storing it in the memory.

20. The method according to claim 16, further comprising calculating the probable symbols and storing the calculated probable symbols in the memory.

21. The method according to claim 16, wherein the table comprises columns or rows, each column or row corresponding to a respective bin and holding a delta range value and probable symbol; and wherein the method further comprises iterating through each column or row and updating a delta range value and probable symbol.

22. The method according to claim 16, wherein the table comprises a two-level table with a first coarse level containing multiples of delta range values and probable symbols; and a second fine level containing any remainder delta range values and probable symbols.

23. The method according to claim 16, further comprising performing inverse binarization after parallel decoding to form original symbols that had been encoded.
